(19) United States
(12) Patent Application Publication
(10) Pub. No.: US 2007/0026304 A1
(43) Pub. Date: Feb. 1, 2007

(54) Battery module and restraint rod

(76) Inventors: Yoon-Cheol Jeon, Yongin (KR); Tae-Yong Kim, Yongin (KR)

Correspondence Address: LEE & MORSE, P.C., 3141 FAIRVIEW PARK DRIVE, SUITE 500, FALLS CHURCH, VA, 22042, US

(21) Appl. No.: 11/492,998

(22) Filed: Jul. 26, 2006

(30) Foreign Application Priority Data
Jul. 29, 2005 (KR) 10-2005-0069484

(51) Int. Cl. H01M 6/42; H01M 10/50

(52) U.S. Cl. 429/156; 429/159; 429/120

(57) ABSTRACT

A battery module includes an aggregate cell including a plurality of unit cells, a pair of end plates arranged respectively at first and second sides of the aggregate cell, and a restraint rod fastened with the end plates and fixing the end plates to the aggregate cell, the restraint rod including a rod part, and a head part mounted on a first end of the rod part, the head part being moveable relative to the rod part.

### BACKGROUND OF THE INVENTION

1. Field of the Invention

The present invention relates to a battery module formed by connecting a plurality of unit cells. More particularly, the present invention relates to an improved battery module that can maintain uniform contact between a restraint rod and an end plate for fixing unit cells together, and a restraint rod for fixing the unit cells applied to the battery module.

2. Description of the Related Art

In general, unlike non-rechargeable batteries, rechargeable batteries may be recharged. Low-capacity rechargeable batteries may be used as a power source for various small portable electronic devices, e.g., cellular phones, laptop computers, and camcorders. Large-capacity rechargeable batteries may be used for motor-driven devices, e.g., hybrid electric vehicles.

Rechargeable batteries can be classified according to their outer shape as, e.g., cylindrical and prismatic batteries. In addition, rechargeable batteries may be multiply connected in series to thereby form a battery module that can be used as a power source for electrical devices, e.g., hybrid electric vehicles, requiring large capacity batteries.

In a general battery module, a rechargeable battery (hereinafter, referred to as “a unit cell”) may include an electrode assembly including positive and negative electrodes and a separator interposed between the positive and negative electrodes, a case for housing the electrode assembly, a cap assembly combined with the case and sealing it, and positive and negative terminals electrically connected to the positive and negative electrodes, respectively.

When the unit cell is fabricated as a prism, the positive and negative terminals may be mounted to externally protrude outward from the cap assembly, thereby being exposed to the environment outside of the unit cell.

When the unit cells form a battery module, the unit cells may be arranged in an alternating manner to connect positive and negative terminals of adjacent unit cells together. The positive and negative terminals may thereby be connected to each other through a conductor. The conductor may be fixed to the positive and negative terminals by nuts.

The battery module may be completed by connecting several to tens of unit cells together. The unit cells may be arranged in one row, and can thereby be formed into one aggregate structure with an end plate at each end. The end plates may be disposed at the outermost ends of the aggregate structure and may closely contact the outermost ends of the aggregate structure and a restraint rod. The restraint rod may be fixed on the end plates by a nut.

In other words, when end plates are closely disposed at the outermost ends of the cell aggregate structure, and fastened with a restraint rod by a nut, the end plates can press towards each other and tightly fix together the unit cells in the cell aggregate structure.

However, unit cells may swell, bend or deform when they are over charged or over discharged. Such swelling, bending and/or deformation of one or more of the unit cells in the battery module may bend and/or deform one or more of the end plates. The transformation of end plates may cause a portion of the end plate that contacts a restraint rod to loosen contact with and/or disconnect from the restraint rod, resulting in a contact failure between the end plate and the restraint rod.

Such contact failure may cause stress to be localized onto other portion(s) of the end plate contacting the restraint rod because the stress may not be evenly distributed. Thus, as a result of such contact failure stress existing between the restraint rod and corresponding contacting portion of the end plate may be concentrated on other contacting portions of the restraint rod and corresponding contact portion(s).

Accordingly, a conventional battery module may have problems resulting from deformation of an assembled structure because the end plates and/or the restraint rod may easily deform as a result of a weak fastening strength between the restraint rod against the end plates. Such deformation of the assembled structure may deteriorate a performance of the battery module.

This problem may be aggravated when the end plates are less than 2 mm thick. Having to form end plates with a thickness of 2 mm or more may hinder efforts of reducing a size of a battery module.

The above information disclosed in this background section is only for enhancement of understanding of the background of the invention and therefore it may contain information that does not form the prior art that is already known in this country to a person of ordinary skill in the art.

### SUMMARY OF THE INVENTION

The present invention is therefore directed to a restraint rod structure, which substantially overcomes one or more of the problems due to limitations and disadvantages of the related art.

It is therefore a feature of an embodiment of the present invention to provide a restraint rod structure including a head part that continuously maintains uniform contact with an end plate, even when the end plate is deformed, thereby reducing and/or preventing local concentration of stress.

It is therefore a separate feature of an embodiment of the present invention to provide an improved restraint rod structure, employable by a battery module, which reduces and/or prevents the concentration of stress generated at contact points of end plates with the restraint rod.

It is therefore a separate feature of an embodiment of the present invention to provide a battery module having a higher safety index than known comparable battery modules.

It is therefore a separate feature of an embodiment of the present invention to provide a restraint rod for a battery module that can be designed to be lighter than known restraint rods, thereby decreasing an overall weight of a battery module.

It is therefore a separate feature of an embodiment of the present invention to provide a restraint rod for a battery module that can be designed to be thinner end plates than known restraint rods, thereby decreasing an overall size of a battery module.

It is therefore a separate feature of an embodiment of the present invention to provide a more reliable battery module by providing a restraint rod structure that can maintain uniform contact with end plates, and thereby, reduce and/or prevent excessive deformation of the battery module.

It is therefore a separate feature of an embodiment of the present invention to provide a battery module that may be used as a power source for a motor-driven device requiring high power and large capacity, e.g., a hybrid electric vehicle (HEV), an electric vehicle (EV), a cordless cleaner, a motorbike, an electric scooter, etc.

At least one of the above and other features and advantages of the present invention may be realized by providing a battery module that includes an aggregate cell including a plurality of unit cells, a pair of end plates arranged respectively at first and second sides of the aggregate cell, and a restraint rod fastened with the end plates and fixing the end plates to the aggregate cell, the restraint rod including a rod part, and a head part mounted on a first end of the rod part, the head part being moveable relative to the rod part.

The end plates may include a plurality of fastening members protruding from sides thereof. The fastening members may include a hole through which the restraint rod is penetrated. The rod part may include a screw thread portion for being fastened to a nut, the screw thread portion may be at a second end of the rod part that is opposite to the first end of the rod part. The head part may be mounted at the first end of the rod part in a ball joint manner. The head part may have a projecting portion projecting from a side thereof, and the rod part may have a groove at the first end thereof for receiving the projecting portion of the head part. The rod part may have a projecting portion projecting from the first end thereof, and the head part may have a groove for receiving the projecting portion of the rod part. The projecting portion may be a ball shaped projection, and the groove may be a spherical shaped groove.

The head part may have a slanted side that faces the respective one of the end plates. The slanted side may have a substantially conical cross-sectional shape. A groove or a projecting portion may be formed at a tip of the conical cross-sectional shape. The unit cell may be a prismatic cell. A cell barrier may be mounted between the unit cells. The battery module may be used to drive a motor.

At least one of the above and other features and advantages of the present invention may be separately realized by providing a restraint rod for fixing a unit cell of a battery module, including a rod part extended in a length direction, a head part moveably secured to a first end of the rod part, the head part being moveable relative to the rod part.

The rod part may have a screw thread for being fastened with a nut at a second end of the rod part that is opposite to the first end. The head part may be mounted at the first end of the rod part in a ball joint manner. One of the head part and the rod part may have a projecting portion projecting therefrom, and the other of the head part and the rod part has a groove for receiving the projecting portion. The projecting portion may be a ball shaped projection, and the groove may be a spherical shaped groove.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a battery module according to an exemplary embodiment of the present invention;

FIG. 2 illustrates a perspective view of the battery module illustrated in FIG. 1 in an assembled state;

FIG. 3 illustrates a partial cross-sectional view of an exemplary structure of a restraint rod, for a battery module, employing one or more aspects of the present invention;

FIG. 4 illustrates a partial cross-sectional view of another exemplary structure of a restraint rod of a battery module, for a battery module, employing one or more aspects of the present invention; and

FIGS. 5A and 5B illustrate schematic cross-sectional views of a portion of a battery module, employing one or more aspects of the invention, in an normal state and in a deformed state, respectively.

### DETAILED DESCRIPTION OF THE INVENTION

Korean Patent Application No. 10-2005-0069484, filed on Jul. 29, 2005, in the Korean Intellectual Property Office, and entitled “Battery Module and Restraint Rod,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when an element is referred to as being “fixed to” another element, it can be directly on the other element, or intervening element(s) may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Like reference numerals refer to like elements throughout.

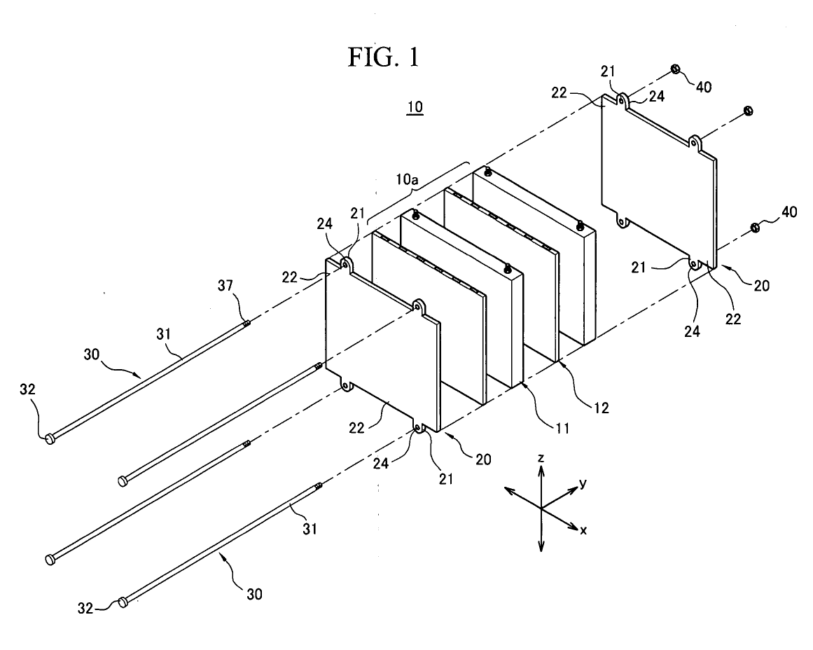

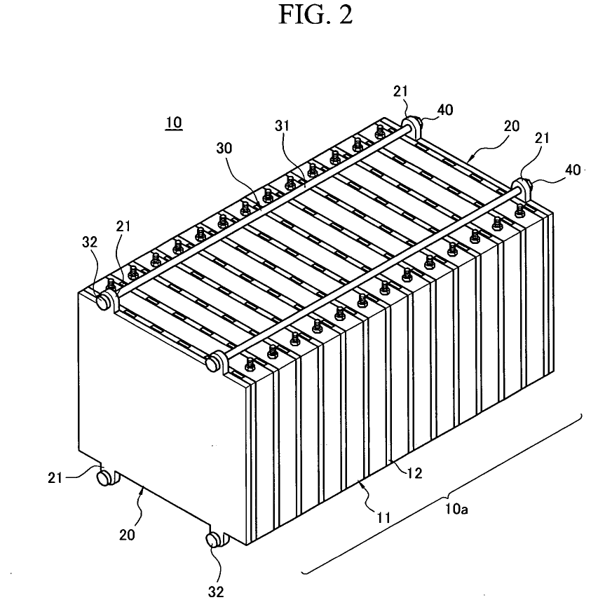

FIG. 1 illustrates an exploded perspective view of a battery module according to an exemplary embodiment of the present invention, and FIG. 2 illustrates a perspective view of the battery module illustrated in FIG. 1 in an assembled state.

As illustrated in FIGS. 1 and 2, the battery module 10 may include an aggregate cell 10a, restraint rod(s) 30 and a pair of end plates 20. The aggregate cell 10a may include a plurality of unit cells 11, which may be stacked, e.g., in series, and a cell barrier 12, which may be disposed between the unit cells 11 to maintain a predetermined distance between adjacent ones of the unit cells 11. Elements, e.g., unit cells 11, cell barrier 12, of the aggregate cell 10a may be secured together by a pair of end plates 20, and restraint rod(s) 30, thereby forming a battery module 10.

As illustrated in FIGS. 1 and 2, the battery module 10 may include an aggregate cell 10a including a plurality of unit cells 11 arranged, e.g., in one row at predetermined intervals. The capacity of such a battery module 10 generally depends on a number and a capacity of each of the unit cells 11, and thus, such a battery module 10 may have a large capacity.

In the exemplary embodiments of the invention illustrated in the accompanying FIGS. 1-5B, the unit cells 11 are prismatic-type cells. However, embodiments of the invention are not limited to prismatic-type unit cells.

Each unit cell 11 may be a rechargeable battery that may be formed by housing an electrode assembly (not illustrated) into a case. The electrode assembly may include positive and negative electrodes and a separator interposed between the positive and negative electrodes. The electrode assembly, and thus, the battery, may be charged and discharged with a predetermined amount of current.

A cell barrier 12 may be provided between adjacent ones of the plurality of unit cells 11. The cell barrier 12 may enable a distance to be maintained between the adjacent one of the plurality of unit cells 11. The cell barrier 12 may circulate a coolant and may absorb heat to help maintain the adjacent ones of the plurality of unit cells 11 cool.

In embodiments of the invention, each of the unit cell(s) 11, the cell barrier(s) 12 of the aggregate cell 10a and the end plates 20 together forming a battery module 10 may have a substantially same size and shape along a plane, e.g., x-z plane, that is substantially perpendicular to the first direction, e.g., y-direction, that the restraint rod 30 extends. Thus, in embodiments of the invention, the battery module 12 may have a substantially tubular, e.g., rectangular, cylindrical, etc., boundary defined by exposed outer surfaces of, e.g., the end plates 20, the unit cell(s) 11 and the cell barrier(s) 12.

As discussed above, elements, e.g., unit cells 11, cell barriers 12, of the aggregate cell 10a may be secured together by a pair of end plates 20, and restraint rod(s) 30 to form a battery module 10. Each of the pair of end plates 20 may be closely attached to outermost elements, e.g., unit cells 11, cell barriers 12, of the aggregate cell 10a. In embodiments of the invention, the pair of end plates 20 may be attached to outer surfaces of the outermost ones of the unit cells 11, and may sandwich all the unit cells 11 between them.

In embodiments of the invention, the restraint rod 30 may include a rod part 31 extending, e.g., in the first direction, e.g., y-direction, and a head part 32. The head part 32 may be disposed, e.g., at one end of the rod part 31.

Each end plate 20 may include a plate-like member 22 and a fastening member 21. The plate-like member 22 may have a same size as that of an entire side of the unit cell 11 to which the plate-like member 22 may be closely attached. In embodiments of the invention, the fastening member 21 may be a ring-like or partial-ring like protrusion from a corresponding end of the end plates 20. The fastening member(s) 21 may, at least partially define a receiving space 24 through which that the rod part 31 of the restraint rod 30 may be inserted and secured to form the battery module 10. For example, the fastening member 21 together with a respective portion of the end plate 20 may define the receiving space 24.

In embodiments of the invention with a fastening member 21 in the form of a ring-like or partial ring-like protrusion, the fastening member 21 may have a shape that corresponds to a shape, e.g., rectangular, square, circular, elliptical ring, etc. and/or size of the rod part 31. The fastening member 21 may be integrally formed and/or may protrude from ends of the plate-like member 22. In embodiments of the invention, the fastening members 21 may protrude from opposing ends, e.g., top and bottom ends, of the plate-like member 22. In embodiments of the invention, the fastening members 21 may be aligned on opposing ends of the plate-like member 22. In embodiments of the invention, each pair of the end plates 20 may have a same number and a same arrangement of the fastening members 21. In the exemplary embodiments of the invention illustrated in FIGS. 1-5B, each end plate 20 includes four fastening members 21. However, embodiments of the invention are not limited to such a structure and may include more than or less than four fastening members 21.

In embodiments of the invention, the pair of end plates 20 may completely sandwich all the unit cells 11 between them, such that when viewing the battery module 10 from the first direction, e.g., y-direction, perpendicular to a plane, e.g., x-z plane, along which the end plates 20 may extend, the unit cells 11 and/or cell barriers 12 arranged between the pair of end plates 20 may not be observed. In embodiments of the invention, the pair of end plates may sandwich all the unit cells 11 between them, but when viewing the battery module 10 from the first direction, e.g., y-direction, perpendicular to a plane, e.g., x-z plane, along which the end plates 20 may extend, it may be possible to see portions of one or more unit cells 11 between them. In embodiments of the invention, when viewing the battery module 10 from the first direction, e.g., y-direction, perpendicular to a plane, e.g., x-z plane, along which the end plates 20 may extend, a portion of each of the end plates 20, e.g., the fastening member(s) 21, may protrude beyond respective portions of the unit cells 11 sandwiched between them.

For example, when viewing FIGS. 1 and 2, one of the pair of end plates 20 may be attached to an outer surface of an element, e.g., unit cell 11, cell barrier 12, of the battery module 10 that is first along the first direction, i.e., the y-direction, and the other of the pair of end plates 20 may be attached to an outer surface of an element, e.g., unit cell 11, cell barrier 12, of the battery module 10 that is last along the first direction, e.g., the y-direction. In the exemplary embodiment illustrated in FIG. 2, one of the pair of end plates 20 is attached to an outer surface of a first one of the cell barriers 12 along the first direction, i.e., y-direction, and the other of the pair of end plates 20 is attached to an outer surface of a last one of the cell barriers 12 along the first direction, i.e., y-direction.

Although only one pair of end plates 20 is illustrated in the exemplary embodiments illustrated FIGS. 1-5B, embodiments of the invention may include more than two end plates 20, i.e., more than one pair of end plates 20. Although four restraint rods 30 are shown in the exemplary embodiments illustrated in FIGS. 1-5B, embodiments of the invention may employ more than or less than four restraint rods 30.

As illustrated in FIGS. 1 and 2, a plurality of restraint rods 30 may fasten and connect respective portions of the pair of end plates 20 together with a nut 40 fastened at an end of each of the restraint rods 30, thereby forming a battery module 10 with the cell barriers 12 and the unit cells 11 arranged and secured between the pair of end plates 20.

In embodiments of the invention, the rod part 31 of the restraint rod 30 may extend in the first direction, e.g., y-direction, so as to extend through corresponding ones of the receiving spaces 24 of the pair of end plates 20. As shown in FIG. 2, the head part 32 of the restraint rod 30 may be disposed at one end of the rod part 31 and may contact an outer surface of the fastening member 21 of the one of the end plates 20. In embodiments of the invention, the rod part 31 may be a long pole-like member. The head part 32 of the restraint rod 30 may have shape and/or size that prevents the head part 32 from entering and/or passing through the receiving space 24. The head part 32 may be formed as a disk, e.g., circular disk, with a larger width and/or diameter than that of the receiving space 24 of the fastening member 21, so that the head part 32 cannot unintentionally slip through the receiving space 24.

The rod part 31 may have a screw thread portion 37 on an outer surface, e.g., circumferential surface, of an end opposite to the head part 32. The screw thread portion 37 may be secured with a nut 40.

Referring to FIGS. 1 and 2, the restraint rod 30 may be engaged with the respective fastening members 21 of the pair of end plates 20 by inserting the rod part 31 of the restraint rod 30 into the corresponding receiving spaces 24 defined by the corresponding fastening members 21.

For example, the rod part 31 of restraint rod 30 may be inserted into respective receiving spaces 24 of the pair of end plates 20, and may be secured to the respective fastening members 21 with a nut 40 secured to the screw thread portion 37 of the rod part 31. By tightening the nut 40 to the rod part 31, the pair of end plates 20, which may be arranged at outer ends of the aggregate cell 10a, may be pressed closer together, thereby pressing and fixing together the elements, e.g., unit cells 11 and cell barriers 12, of the aggregate cell 10a between them.

When the restraint rod 30 and the pair of end plates 20 are in an engaged state, one end, e.g., the head portion 32, of the restraint rod 30, may contact an outer surface of a fastening member 21 of one of the pair of end plates 20, and a nut 40 screwed onto another end of the restraint rod 30 may contact an outer surface of the respective corresponding fastening member 21 of the other one of the pair of end plates 20. When the restraint rod 30 is fastened to the end plates 20, the battery module 10 may be tightened and fixed by the head part 32 extended from the rod part 31 and the nut 40 fastened at the end of the rod part 31.

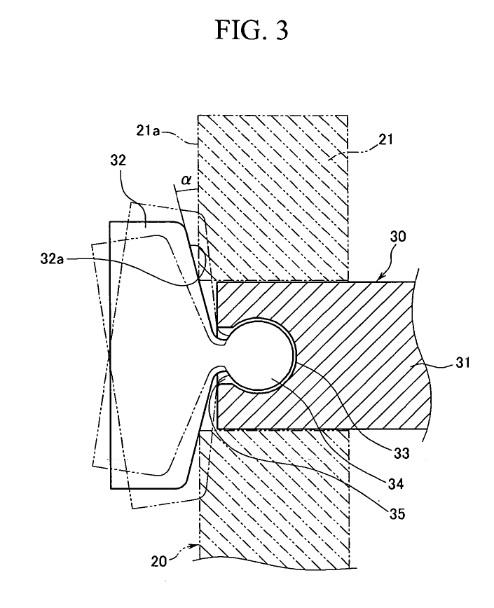

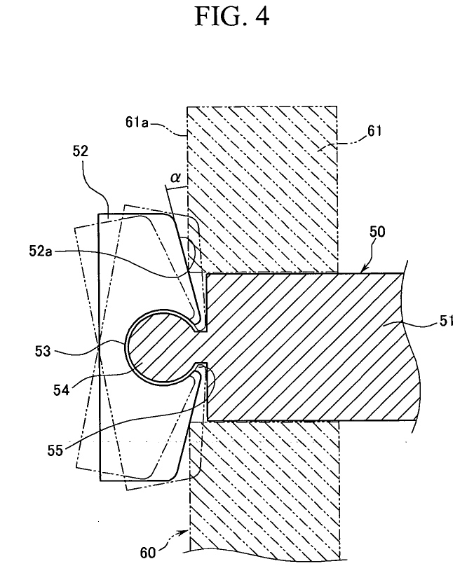

FIGS. 3 and 4 illustrate partial cross-sectional views of exemplary structures of a restraint rod, for a battery module, employing one or more aspects of the present invention.

As illustrated in FIG. 3, the head part 32 and the rod part 31 of a restraint rod 32 may be combined with each other in a ball joint manner. Thus, in embodiments of the invention, the head part 32 may freely move, in any direction, relative the rod part 31 and still maintain contact with the rod part 31.

Referring to FIG. 3, in embodiments of the invention, the rod part 31 may include a groove 33, e.g., a spherical groove, at an end of the rod part 31 to be connected to the head 32. The groove 33 may be integrally formed at the respective end of the rod part 31. The head part 32 may include an insertion portion 34, e.g., a spherical structure, having a size and/or shape corresponding to the groove 33. When the insertion portion 34 is inserted into and fitted with the groove 33, the head part 32 and the rod part 31 may be in a secured state.

The rod part 31 may include an opening 35 communicating and corresponding to the groove 33. The opening 35 may be formed to be relative smaller than a maximum width or diameter of the groove 33, so that after the insertion portion 34 of the head part 32 is inserted into and received by the groove 33, the head part 32 cannot slip out of the groove 33.

In embodiments of the invention, the insertion portion 34 of the head part 32 may have a predetermined curvature formed through a rounding process. Such a predetermined curvature of the insertion portion 34 may enable the head part 32 to be free from cracks that may result due to concentration of stress.

As illustrated in FIG. 3, in embodiments, an internal side 32a of the head part 32 may slant toward a portion of the heat part 32 from which the insertion portion 34 may project. When the insertion portion 34 of the head part 32 is engaged with the groove 33, portions of the internal side 32a of the head part 32 may not contact the respective end plate 20. As illustrated in FIG. 3, in embodiments of the invention, a portion of the internal side 32a above and below the insertion portion 34 may contact a surface 21a of the respective fastening member 21 of the respective end plate 20.

When the insertion portion 34 of the head part 32 is engaged with the groove 33, portions of the internal side 32a of the head part may form a predetermined angle α with an outer side 21a of the respective fastening member 21 of the respective end plate 20. The angle α between the internal side 32a of the head part 32 and the outer side 21a of fastening member 21 has no set value and may be set depending on many factors, e.g., respective shapes, materials, number of restraint rods, sizes, etc. of the elements of a battery module 10.

By providing an internal side 32a that is slanted, the head part 32 may move freely relative to the groove 33 and the respective end plate 20, as illustrated, e.g., by a dotted line in FIG. 3. In embodiments of the invention, the insertion portion 34 may have a spherical ball like shape projecting from a tip of a slanted, e.g., cone-like, inner side 32a, the groove 33 may have a spherical shape corresponding to the shape of the insertion portion 34, and the insertion portion 34 may move freely within the groove 33. The head part 32, e.g., the internal side 32a of the head part, may also move freely, in any direction, relative to the outer side 21a of the fastening member 21 while maintaining contact with fastening member 21 on opposing sides of the insertion portion 34.

In embodiments of the invention, the head part 32, e.g., the internal side 32a, may move freely, in any direction, relative to the outer side 21a of the fastening member 21 while maintaining contact with an entire boundary, e.g., outer circumference, of the receiving space 24 end plate 20. The head part 32 may move freely, in any direction, relative to the fastening member 21 while maintaining contact with an entire boundary, along an x-z plane, of the receiving space 24 of the end plate 20. In embodiments of the invention, the boundary of the receiving space 24 may be defined by a combination of the plate like member 22 and the fastening member 21.

Although FIGS. 1 and 2 illustrate embodiments of a restraint rod 30 with a rod part 31 including a head part 32 at one end and a screw thread portion 37 at another end, embodiments of the invention are not limited to such a structure. In embodiments of the invention, e.g., a restraint rod 30 may include rod part 31 having a head part 32 at each end thereof.

FIG. 4 illustrates another exemplary embodiment of a restraint rod employing one or more aspects of the invention. The restraint rod 50 may include a protruding portion 54 and a head portion 52. The restraint rod 50 may be formed by inserting the protruding portion 54 of the rod part 51 into the groove 53 of the head part 52.

The protruding portion 54 may be, e.g., ball shaped protrusion and one or both ends of the rod part 51 may include a protruding portion 54. In embodiments of the invention, the head part 52 may include a groove 53, e.g., a spherical groove, for receiving the protruding portion 54. The groove 53 may be provided at a substantially central portion of an internal side 52a of the head part 52.

In embodiments of the invention, the restraint rod 50 may have a structure such that the protruding portion 54 of the rod part 51 may move freely inside the groove 53 of the head part 52. Thus, the head part 52 can move freely, in any direction, relative to the rod part 51.

In embodiments of the invention, the head part 52 may include an opening 55 corresponding to and/or communicating with the groove 53 formed therein. The opening 55 may be smaller than a width or diameter of the groove 53 so that the protruding portion 54 cannot slip out from the groove 53. The opening 55 may be arranged at a center of the internal side 52a.

In embodiments of the invention, the internal side 52a of the head part 52 may be slanted outward toward the opening 55, as illustrated in FIG. 4. By providing an internal side 52a that is slanted, the head part 52 may move freely relative to the protruding portion 54 and the respective end plate 60, as illustrated, e.g., by a doffed line in FIG. 4. In embodiments of a restraint rod according to the invention, the protruding portion 54 may have a spherical ball like shape projecting from one or both ends of the rod part 51, the head part 52 may have a groove 53, having a spherical shape corresponding to the shape of the protruding portion 54, and projecting inward from a tip of a slanted, e.g., cone-like, inner side 52a, and the insertion portion 54 may move freely within the groove 53. The head part 52, e.g., the internal side 52a of the head part 52, may also move freely, in any direction, relative to the outer side 61a of the fastening member 61 while maintaining contact with fastening member 61 on opposing sides of the projecting portion 54.

In embodiments of the invention, the head part 52, e.g., the internal side 52a, may move freely, in any direction, relative to the outer side 61a of the fastening member 61 while maintaining contact with an entire boundary, e.g., outer circumference, of the receiving space 24 of the end plate 60. The head part 52 may move freely, in any direction, relative to the fastening member 61 while maintaining contact with an entire boundary, along an x-z plane, of the receiving space 24 of the end plate 60.

When the groove 53 of the head part 52 is engaged with the projecting portion 54, portions of the internal side 52a of the head part 52 may form a predetermined angle α with an outer side 61a of the respective fastening member 61 of the respective end plate 60. The angle α between the internal side 52a of the head part 52 and the outer side 61a of fastening member 61 has no set value and may be set depending on many factors, e.g., respective shapes, materials, number of restraint rods, sizes, etc. of the elements of a battery module 10.

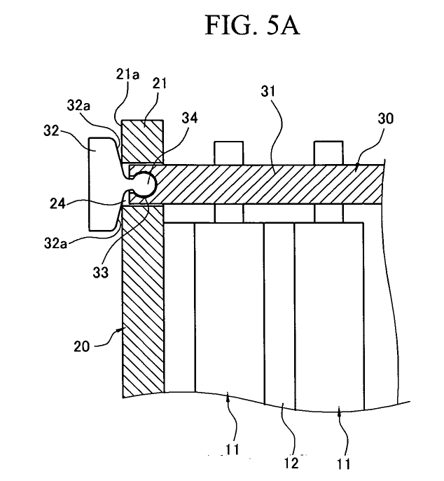

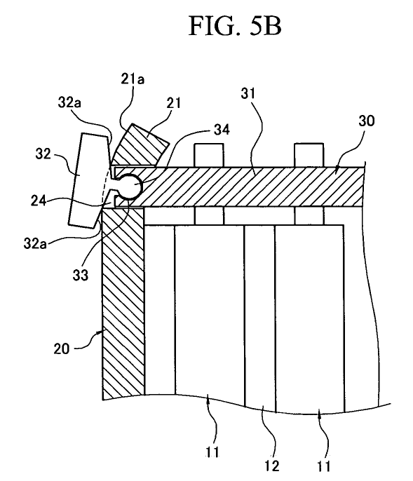

FIGS. 5A and 5B illustrate schematic cross-sectional views of a portion of a battery module, employing one or more aspects of the invention, in a normal state and in a deformed state, respectively. As discussed above with regard to FIGS. 1 and 2, the battery module 10 may include unit cells 11, with cell barriers 12 interposed therebetween, which may be fastened together with end plates 20 and restraint rods 30. The end plates 20 may include fastening members 21 formed at, e.g., bottom and top sides thereof. The fastening members 21 may have receiving spaces 24 for receiving a portion of the rod parts 31 in order to secure the restraint rods 30 to the fastening members 21.

As illustrated in FIG. 5A, when the rod part 31 of the restraint rod 30 is attached with the fastening member 21, the head part 32 of the restraint rod 30 may contact the fastening member 21, while not being able to unintentionally slip away. At the other end of the rod part 31, the screw thread portion 37 of the rod part 31 may penetrate through the receiving space 24 on the fastening member 21 and may be exposed to the outside. The screw thread portion 37 of the rod part 31 may be combined with a nut 40, so that the end plates 20 can apply pressure to the aggregate cell 10a, and thereby form a battery module.

The restraint rod 30 may penetrate the end plates 20 and may extend along the first direction, e.g., y-direction, which is substantially perpendicular to a plane, e.g., x-z plane, along which the end plates 20 may extend. As illustrated in FIG. 5A, the head part 32 of the restraint rod 30 may evenly contact the boundary, e.g., circumference, of the receiving space 24 of the end plate 20. In embodiments of the invention, the head part 32, e.g., the internal side 32a, may move freely, in any direction, relative to the outer side 21a of the fastening member 21 while maintaining contact with an entire boundary, e.g., outer circumference, of the receiving space 24 of the end plate 20. The head part 32 may move freely, in any direction, relative to the fastening member 21 while maintaining contact with an entire boundary, along an x-z plane, of the receiving space 24 of the fastening member 21.

In embodiments of the invention, the head part 32 and the boundary, e.g., circumference, of the receiving space 24 of the end plate 20 may be subject to a uniform or substantially uniformly applied stress.

When a battery module operates, some unit cells 11 therein may be swollen and thereby deformed. Such deformation of the unit cells 11 may subject the end plates 20 at sides of the aggregate cell 10a to be deformed.

FIG. 5B illustrates an end plate 20 in a deformed state. As illustrated in FIG. 5B, the fastening part 21 of the end plate 20 is deformed and bent. As a result of the deformed state of the end plate 20, an orientation of the head part 32 of the restraint rod 30 and the fastening member 21 of the end plate 20 is also changed.

In embodiments of the invention, however, the orientation of the head part 32 of the restraint rod 30 corresponds to the state of the fastening member 21. Thus, when the fastening member 21 is deformed, the orientation of the head part 32 moves relative to the rod part 31 and continuously maintaining uniform contact with the boundary, e.g., circumference, of the receiving space 24 of the end plate 20.

The head part 32 may engage with the rod part 31 in a ball joint manner. Even if the fastening member 21 of the end plate 20 is deformed, the head part 32 may remain engaged with a rod part 31 and may move freely in a ball joint manner, relative to the rod part 31. Embodiments of the invention enable the head part 32 to maintain even contact and/or uniform contact with a boundary, e.g., circumference, of the receiving space 24 in the fastening member 21 of the end plate 20.

Embodiments of the invention separately provide a restraint rod structure having a head part 32 that continuously maintains uniform contact with an end plate 20, regardless of deformation of the end plate 20, reducing and/or preventing local concentration of stress.

Embodiments of the invention separately provide an improved restraint rod structure, employable by a battery module, which reduces and/or prevents the concentration of stress generated at contact points of end plates with the restraint rod.

Embodiments of the invention separately provide a battery module having a higher safety index than known comparable battery modules.

Embodiments of the invention separately provide a restraint rod for a battery module that can be designed to be lighter than known restraint rods, thereby decreasing an overall weight of a battery module.

Embodiments of the invention separately provide a restraint rod for a battery module that can be designed to be thinner end plates than known restraint rods, thereby decreasing an overall size of a battery module.

Embodiments of the invention separately provide a more reliable battery module by providing a restraint rod structure that can maintain uniform contact with end plates, and thereby, reduce and/or prevent excessive deformation.

A battery module of the present invention may be used as a power source for a motor-driven device requiring high power and large capacity, e.g., a hybrid electric vehicle (HEV), an electric vehicle (EV), a cordless cleaner, a motorbike, an electric scooter, and the like.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery module, comprising:
an aggregate cell including a plurality of unit cells;
a pair of end plates arranged respectively at first and second sides of the aggregate cell; and
a restraint rod fastened with the end plates and fixing the end plates to the aggregate cell, the restraint rod including:
a rod part, and
a head part mounted on a first end of the rod part, the head part being moveable relative to the rod part.

2. The battery module as claimed in claim 1, wherein the end plates include a plurality of fastening members protruding from sides thereof.

3. The battery module as claimed in claim 1, wherein the fastening members include a hole through which the restraint rod is penetrated.

4. The battery module as claimed in claim 1, wherein the rod part includes a screw thread portion for being fastened to a nut, the screw thread portion being at a second end of the rod part that is opposite to the first end of the rod part.

5. The battery module as claimed in claim 1, wherein the head part is mounted at the first end of the rod part in a ball joint manner.

6. The battery module as claimed in claim 1, wherein the head part has a projecting portion projecting from a side thereof, and the rod part has a groove at the first end thereof for receiving the projecting portion of the head part.

7. The battery module as claimed in claim 6, wherein the projecting portion is a ball shaped projection, and the groove is a spherical shaped groove.

8. The battery module as claimed in claim 1, wherein the rod part has a projecting portion projecting from the first end thereof, and the head part has a groove for receiving the projecting portion of the rod part.

9. The battery module as claimed in claim 8, wherein the projecting portion is a ball shaped projection, and the groove is a spherical shaped groove.

10. The battery module as claimed in claim 1, wherein the head part has a slanted side that faces the respective one of the end plates.

11. The battery module as claimed in claim 10, wherein the slanted side has a substantially conical cross-sectional shape.

12. The battery module as claimed in claim 11, wherein a groove or a projecting portion is formed at a tip of the conical cross-sectional shape.

13. The battery module as claimed in claim 1, wherein the unit cell is a prismatic cell.

14. The battery module as claimed in claim 1, wherein a cell barrier is mounted between the unit cells.

15. The battery module as claimed in claim 1, wherein the battery module is for driving a motor.

16. A restraint rod for fixing a unit cell of a battery module, comprising:
a rod part extended in a length direction; and
a head part moveably secured to a first end of the rod part, the head part being moveable relative to the rod part.

17. The restraint rod as claimed in claim 16, wherein the rod part has a screw thread for being fastened with a nut at a second end of the rod part that is opposite to the first end.

18. The restraint rod as claimed in claim 16, wherein the head part is mounted at the first end of the rod part in a ball joint manner.

19. The restraint rod as claimed in claim 16, wherein one of the head part and the rod part has a projecting portion projecting therefrom, and the other of the head part and the rod part has a groove for receiving the projecting portion.

20. The restraint rod as claimed in claim 16, wherein the projecting portion is a ball shaped projection, and the groove is a spherical shaped groove.
